(19) United States
(12) Patent Application Publication
(10) Pub. No.: US 2024/0012459 A1
(43) Pub. Date: Jan. 11, 2024

(54) RENEWABLE ENERGY ALLOCATION TO HARDWARE DEVICES

(71) Applicant: Intel Corporation, Santa Clara, CA (US)

(72) Inventors: Francesc GUIM BERNAT, Barcelona (ES); Karthik KUMAR, Chandler, AZ (US); John J. BROWNE, Limerick (IE); Chris MACNAMARA, Limerick (IE); Patrick CONNOR, Beaverton, OR (US)

(73) Assignee: Intel Corporation, Santa Clara, CA (US)

(21) Appl. No.: 18/371,949

(22) Filed: Sep. 22, 2023

(51) Int. Cl. G06F 1/26

(52) U.S. Cl. CPC G06F 1/266

(57) ABSTRACT

Examples described herein relate to receiving a configuration, wherein the configuration is to specify a first level of renewable energy utilized by one or more devices based on telemetry, wherein the telemetry comprises a level of renewable energy supplied to the one or more devices. Based on a second level of available supplied renewable energy, a portion of the first level of available supplied renewable energy can be allocated to one or more devices to perform the process. Based on a third level of available supplied renewable energy, increase renewable energy allocated to the one or more devices, to perform the process, to above the first level.

### BACKGROUND

With the growth in computing capabilities in cloud computing (e.g., data centers and Edge), an increase in power consumption by cloud computing is occurring. Data centers and Edge devices can use renewable and non-renewable energy sources. Renewable, low carbon, or low greenhouse gas emission sources can include solar, wind, hydroelectric, or nuclear energy. Non-renewable energy sources, high carbon sources, or high greenhouse gas emission sources can include fossil fuel, coal, or gas burning energy. Carbon emissions can be measured in terms of CO₂ emissions in kilograms (kg) or other metrics. Green networking is attempting to improve energy efficiency and reduce undesirable energy consumption to reduce the carbon footprint produced by network interface devices and platforms.

### BRIEF DESCRIPTION OF THE DRAWINGS

FIG. 1 shows an example of allocating bandwidth to different traffic classes.

FIG. 2 depicts an example system.

FIG. 3 depicts an example process.

FIG. 4 depicts an example network interface device.

FIGS. 5A-5B depict example network interface devices.

FIG. 6 depicts an example system.

### DETAILED DESCRIPTION

For some network deployments or edge deployments, renewable power sources are the sole source of power because no grid power supply is available. In other cases, grid power supply and renewable sources are both available. However, levels of available renewable energy can vary vastly over time, such as by time of day and month of year (e.g., winter season or summer season). For example, solar power can be most readily available during the daytime and during warmer months (e.g., summer). For example, availability of power can be based on statistical data (e.g., over time, on average, 20% of the supplied energy is renewable and 80% of supplied energy is not renewable). Some computing infrastructures are not able to rely primarily on sporadic non-continuous incoming power. Separation or demarcation between non-renewable grid power and renewable power may not be available and devices can be powered without control of an amount of renewable power because devices may not have capability to control usage of a level of renewable and a level of non-renewable energy.

Various examples herein provide a configuration to specify an amount of renewable energy and/or non-renewable energy to supply to a computing system to perform one or more particular processes or workloads or to process packets of a particular flow based on telemetry. In some examples, based on artificial intelligence (AI) models, inference, and/or machine learning (ML), where a level of supplied renewable energy exceeds a level for an amount of time and is predicted to exceed the level based on historical data on supplied renewable energy, the configuration can indicate to boost a level of renewable energy utilized to perform one or more particular processes or workloads or to process packets of a particular flow. In some examples, the configuration can indicate to store supplied renewable energy in a battery or other energy storage system (ESS) (e.g., battery, flow-battery, flywheel, gravity battery, thermal battery, compression battery, hydrogen energy storage, phase change energy storage, ultra capacitors, Sabatier process) if renewable energy is available in excess of consumed renewable energy. The stored renewable energy can be utilized to supply energy to perform one or more particular processes or workloads or to process packets of a particular flow for a tenant or generally available for use to perform processes or workloads associated with the tenant or process packets associated with the tenant. For example, the configuration can indicate to boost a level of renewable energy utilized to perform one or more particular processes or workloads or to process packets of a particular flow by use of battery-stored renewable energy. For example, the telemetry can indicate a level of supplied renewable energy and a level of supplied non-renewable energy. For example, to differentiate a level of supplied renewable energy from a level of supplied non-renewable energy, renewable energy can be supplied by a first inlet whereas non-renewable energy can be supplied by a second inlet. Renewable power management schemes can increase renewable energy consumption to allow customers to reduce total cost of ownership (TCO) or otherwise comply with green energy requirements.

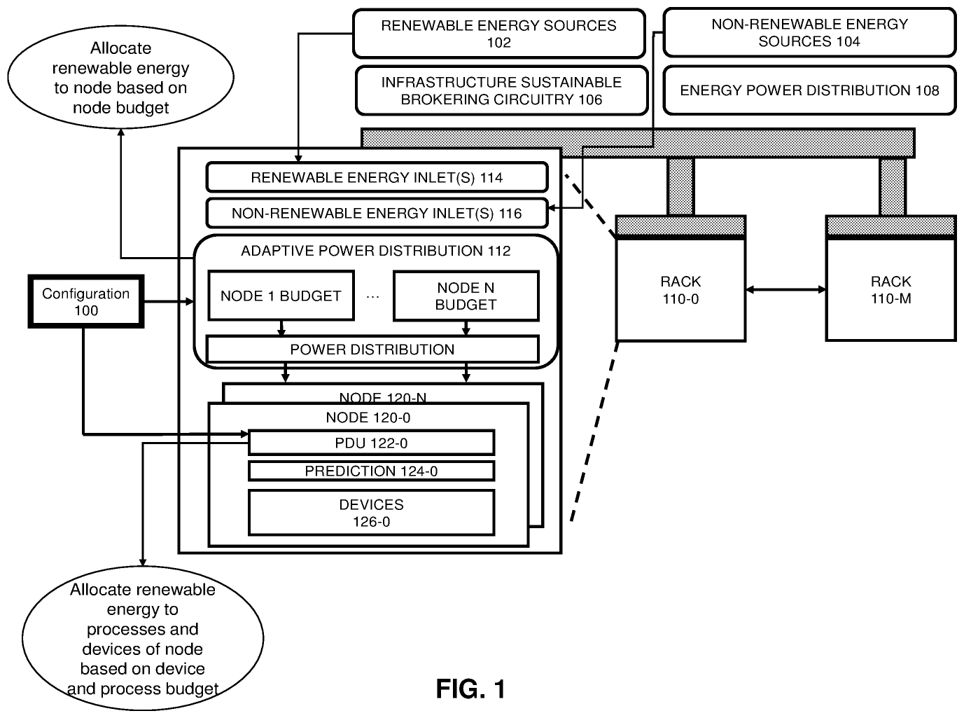

FIG. 1 depicts an example system. The system can be used for servers, racks of servers, datacenters, central offices, and/or Edge deployments. Renewable energy sources 102 can provide energy based at least on one or more of solar, wind, or hydroelectric sources. Renewable energy sources 102 can provide energy based on low carbon or low greenhouse gas emissions or low carbon intensity. Renewable energy could be stored in batteries for consumption at a later time and provided to power devices for execution of processes for a particular tenant, cloud service provider (CSP), communications service provider (CoSP), or others. Non-renewable energy sources 104 can provide energy based at least on one or more of: nuclear energy, coal, or gas. Non-renewable energy sources 104 can provide energy from high carbon sources or high greenhouse gas emission sources. In some examples, tenants of a CSP can track carbon emissions by counting of emissions from parts of a system used by tenant processes.

For example, physical portioning of power sources (e.g., different input cords) can provide separate power from renewable energy source 102 and non-renewable energy source 104. Various examples provide power distribution units for servers with a single power source and telemetry communications that provides information on measured current levels of renewable energy and non-renewable energy. Infrastructure brokering 106 may determine a level of renewable energy to distribute to racks 110-0 to 110-M, where M is an integer. Infrastructure brokering 106 may provide information to adaptive power distribution circuitry of a rack on the current cost of the energy. Infrastructure brokering 106 may reserve a certain amount of renewable energy (e.g., store the renewable energy in a battery or other energy storage) for future supply. Energy power distribution 108 can distribute energy from renewable energy sources 102 and non-renewable energy sources 104 to one or more of racks 110-0 to 110-M, where M is an integer.

An example discussion follows for rack 110-0. The example of rack 110-0 can apply to one or more of racks 110-1 to 110-M, although a rack can vary from another rack. For example, for rack 110-0, adaptive power distribution 112 can receive power from a renewable energy inlet 114 that receives energy from renewable energy sources 102 and a non-renewable energy inlet 116 that receives energy from non-renewable energy sources 104. An energy inlet can include a cable dedicated to provide energy from one or more non-renewable energy sources and a second cable dedicated to provide energy from one or more renewable energy sources. In some examples, an inlet provides both renewable and non-renewable energy, and adaptive power distribution 112 can measure a level and rate of renewable and non-renewable energy provided at one or more inlets. Energy can be measured in kilowatts-hour (kWh) or Joule per second.

For example, adaptive power distribution 112 can differentiate an amount or rate of supplied renewable energy from non-renewable energy based on the power cable that provides the power. For example, adaptive power distribution 112 can differentiate an amount or rate of supplied renewable energy from non-renewable energy based on telemetry. Telemetry can include a current level of supplied renewable energy and a current level of supplied non-renewable energy.

By configuration 100, an orchestrator, system administrator of a cloud service provider (CSP) or communication service provider (CoSP), or tenant can specify a budget for renewable and non-renewable energy to be allocated to one or more of: one or more of racks 110-0 to 110-M, one or more of nodes 120-0 to 120-N, one or more devices in a node, or one or more processes executed by a node. In some examples, configuration 100 can be based on a service level agreement (SLA) and can include an application program interface (API), configuration file, executable binary, or others. For example, configuration 100 can specify cost policies for non-renewable energy and renewable energy to utilize more available renewable energy as well as a limit on monetary cost of renewable and/or non-renewable energy utilization (e.g., monetary cost for kWh). For a process or flow of packets, configuration 100 can specify an amount of renewable energy to allocate to execute a workload, whether to boost utilization of renewable energy by circuitry to perform a workload based on excess renewable energy being available (e.g., a rate of renewable energy exceeding a particular level), a process address space identifier (PASID) or identifier(s) of one or more processes that the configuration applies to, or others. In another example, configuration 100 can specify a total or time window limit or cap to the emissions to be associated with a given process and in some examples, execution of the process may only occur when the process can be performed exceeding the total or time window emissions limit.

For example, based on configuration 100, adaptive power distribution 112 can manage renewable and non-renewable power supplied to one or more computing nodes of a rack. For example, configuration 100 can specify renewable and non-renewable power supplied to computing nodes 120-0 to 120-N of rack 110-0, where N is an integer. Nodes 122-0 to 122-N may have different priorities or different monetary cost budget of renewable and non-renewable energy consumption. Adaptive power distribution 112 can distribute renewable power to one or more nodes of a rack depending on priorities of access to renewable energy or monetary cost budgets.

Discussion follows for computing node 120-0 and the example of computing node 120-0 can apply to one or more of computing nodes 120-1 to 120-N. For node 120-0, configuration 100 can indicate per-hardware resource utilization of renewable and non-renewable energy. Configuration 100 can specify an amount of renewable and non-renewable energy for power distribution unit (PDU) 122-0 to allocate to execute a process or workload, whether to boost performance of a process or workload based on more renewable energy being available than a particular level, a process address space identifier (PASID), or others. For example, based on an increase in renewable energy, application of configuration 100 by PDU 122-0 can cause an increase in level of renewable energy allocated to devices 126-0 for execution of a process or workload (e.g., increased supplied power, increased clock signal frequency of operation, increased number of devices, or others). For example, based on configuration 100, PDU 122-0 can increase usage of renewable energy of resources to perform a workload while meeting a service level agreement (SLA) of the workload.

An SLA or SLO can specify at least one or more of: allocated memory bandwidth, allocated memory, allocated storage bandwidth, allocated storage, allocated network interface device bandwidth, allocated number of cores, processor utilization percentage, processor operating frequency, system uptime, number of generated frames per second (FPS), number of operations performed per second (OPS), or other criteria. An example SLA or SLO can be as follows:

| | | | Apply power source |
|---|---|---|---|
| | | | adaptation to control |
| | | | renewable and/or non- |
| Service | Output | Priority | renewable energy usage |
| ID | (floor) | level | (yes/no) |
| 0X2 | 10 frames/ | 10 | Yes |
| | second output | | |
| . . . | . . . | . . . | . . . |

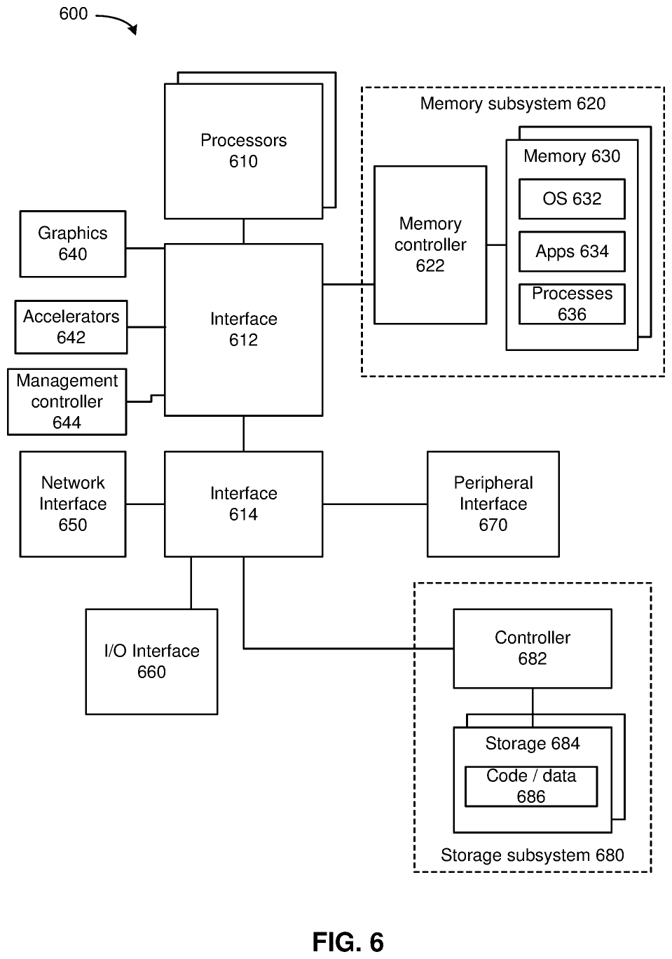

Power distribution unit (PDU) 122-0 can determine a level of supplied renewable energy from a power inlet that provides renewal energy and can determine a level of supplied non-renewable energy from a power inlet that provides non-renewable energy. Node 120-0 can include or access device resources 126-0 such as one or more of: one or more processors (e.g., central processing units (CPUs), graphics processing units (GPUs), XPUs, and so forth); one or more accelerators; one or more application specific integrated circuits (ASICs); one or more field programmable gate arrays (FPGAs); one or more graphics processing units (GPUs); one or more memory devices; one or more storage devices; one or more network interface devices; or others. One or more of nodes 120-0 to 120-N can include circuitry and execute software described at least with respect to FIG. 6.

For example, devices 126-0 of node 120-0 can execute processes for a tenant, where the tenant and/or process are subject to allocation of budget for renewable and non-renewable energy as specified by a node budget in configuration 100. A process can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some processes can perform video processing or media transcoding (e.g., changing the encoding of audio, image, or video files).

PDU 122-0 can adjust resource allocation and usage of renewable energy based on variations in available renewable energy. For example, cooling, work scheduling, and/or clock speed adjustments can be made based on available renewable power and priority of work. For example, a management controller can adjust renewable energy usage available to the resources of devices 126-0 (e.g., processors, memory, interconnects, network interface device, or others) based on an amount of available renewable energy and based on key performance indicators (KPI) in an SLA of a process. KPI can include operations per second, packet processed per second, frames generated or processed per second, or other measures of completed operations.

For at least node 120-0, PDU 122-0 can distribute renewable and non-renewable power to various elements of devices 126-0 (e.g., processors, accelerators, network interface device, memory, etc.) according to configuration 100 for performance of one or more specific processes. For example, PDU 122-0 can allocate renewable and non-renewable energy budget to one or more tenants and one or more tenant processes of node 120-0. In some examples, PDU 122-0 can be positioned in a network interface device, implemented as a discrete circuitry, firmware, and/or software.

Based on configuration 100, PDU 122-0 can utilize telemetry from adaptive power distribution 112 concerning renewable energy to determine when to perform operations of a process. PDU 122-0 can select from use of renewable and non-renewable sources of power in near real-time. Based on energy provided by a particular power inlet or telemetry, PDU 122-0 can determine an amount of utilized renewable energy and non-renewable energy and set power distribution from renewable energy and non-renewable energy sources and control server power management policies (e.g., Running Average Power Limit (RAPL)). RAPL can indicate accumulated energy consumption of various power domains in node 120-0 such as in devices 126-0. Power domains can include: package, processor, server, rack of servers, and so forth. PDU 122-0 can determine when to consume non-renewable energy depending on an available amount of renewable energy and a monetary price or limit on amount of non-renewable energy utilization.

Based on configuration 100, a node can increase the usage of renewable energy to meet or exceed an applicable SLA for the executed processes. In some examples, based on configuration 100, processes with lower priority for utilization of renewable energy can be delayed for execution when more renewable energy is available or can be provided with less renewable energy and/or utilize non-renewable energy.

Prediction 124-0 can predict usage of renewable energy levels based on time of day, season, expected amount of solar energy for a time period, or historical information (e.g., using Local Sidereal Time (LST) of architecture to project expected available energy). Predictions of levels of renewable energy can be used to make power utilization decisions for one or more servers, one or more racks, and one or more processors. Based on predicted amounts of renewable energy available and configuration 100, PDU 122-0 can allocate renewable energy for consumption by devices 126-0 that are to perform operations for a process. In some examples, PDU 122-0 can schedule execution of the process when supplied renewable energy is forecast to be sufficiently high a level to meet a renewable energy goal for the process, based on configuration 100. In other examples, PDU 122-0 can start the execution of the process when the state-of-charge in a renewable energy storage system (e.g., battery, flywheel) is sufficient to provide renewable energy goal for the process.

In some examples, one or more circuitry of one or more of racks 110-0 to 110-M can be implemented as one or more of: one or more processors; one or more programmable packet processing pipelines; one or more accelerators; one or more application specific integrated circuits (ASICs); one or more field programmable gate arrays (FPGAs); one or more memory devices; one or more storage devices; or others.

Devices 126-0 can include or utilize a network interface device. As described herein, a network interface device can choose a route of a packet based on telemetry indicative of renewable energy consumption according to renewable energy heat maps from other network interface devices or switches and priority of packet. The heat map can include current and predicted amounts of available renewable energy.

Various examples provide circuitry in a network interface device of devices 126-0 to receive a configuration (e.g., configuration 100) to control end-to-end renewable and non-renewable energy utilization for forwarding and processing a packet from sender source to destination receiver based on a service level agreement (SLA) or service level objective (SLO). Based on configuration 100, a path to transmit and process packets of a flow from a source to target can be based on an amount of renewable and non-renewable energy to be utilized. A network interface device and node (e.g., node 120-0) can receive renewable and non-renewable energy usage levels for a flow of packets and attempt to select a path so that renewable and non-renewable energy usages fit within end-to-end renewable and non-renewable energy utilization target levels. Based on configuration 100, a budget for renewable and non-renewable energy usages can be specified per-tenant so that there is an aggregation of end-to-end energy budgets for multiple processes executed and networking used for a tenant.

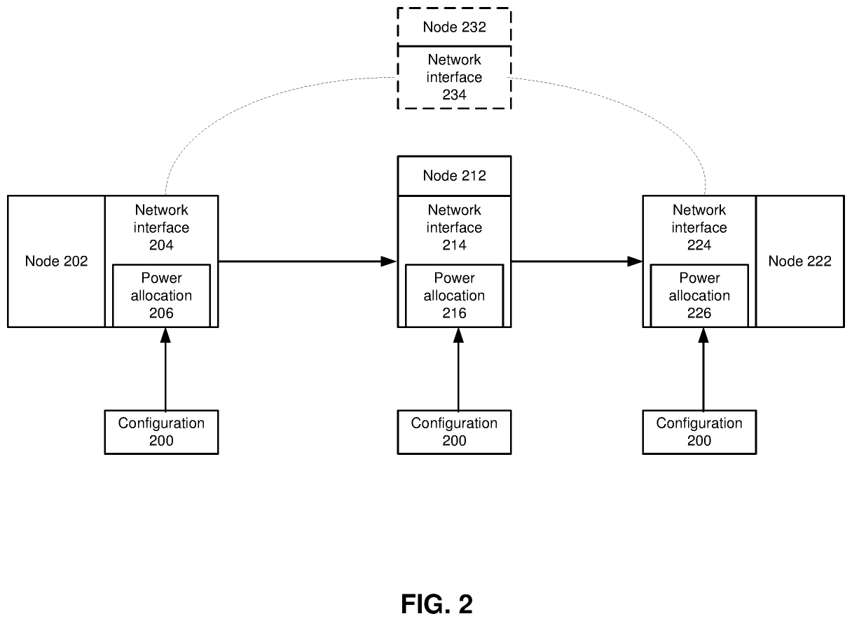

FIG. 2 depicts an example of power allocation for end-to-end packet forwarding and processing. Configuration 200 can specify per packet or per-flow power source type (e.g., renewable, non-renewable, high emission, or low emission). Configuration 200 can specify SLA or KPI rules that are conditional based on the type of power currently available and predicted to be available. SLA can specify an amount of renewable energy usage and carbon usage for certain network bandwidth criteria. For example, configuration 200 can specify that non-renewable power can be used when packet loss rate is ≥0.00X % over Y seconds and when non-renewable power is used, to cap a turbo frequency on CPUs at Z frequency. Configuration 200 can specify that renewable power is used when peak packet latency >A ms or packet times is acceptable for B time duration. Renewable power can be used so that best effort flows are rate limited to C MB/s over D seconds.

In some examples, packets traversing a network (e.g., network interface device 204-234) may include configuration 200 or configuration 200 can be sent to network interface devices 204-234 via control packets by an orchestrator or entered as a configuration by a system administrator. For example, based on configuration 200, sender network interface device 204 can select a route of network devices to endpoint network interface device 224 based on a trade-off between packet forwarding latency, including reliability and congestion, and renewable energy consumption. For example, one or more network interface devices 204, 214, 224, and 234 can receive configuration 200 that indicates a heatmap of available renewable energy at network interface devices 204, 214, 224, and 234. For example, one or more network interface devices 204, 214, 224, and 234 can receive configuration 200 and propagate configuration 200 to another of network interface devices 204, 214, 224, and 234. Sender network interface device 204, associated with node 202, can utilize power allocation 206 to select a renewable energy or low carbon emission aware routing scheme to map a packet through network interface device 214 (instead of through network interface device 234) to endpoint network interface device 224 based on renewable energy availability. For example, network interface device 214 (and node 212) may utilize or have more renewable energy available than network interface device 234 (and node 232) and a path through network interface device 214 to network interface device 224 may provide a similar latency as the path through network interface device 234 (e.g., higher, equal, or lower latency). Note 222 can process packets received by network interface 224. Note that power allocation 216 and 226 can perform similar operations as those of power allocation 206 to select a renewable energy or low carbon emission aware path to a destination.

A network interface device can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth).

A packet may be used herein to refer to various formatted collections of bits that may be sent across a network, such as Ethernet frames, IP packets, Transmission Control Protocol (TCP) segments, User Datagram Protocol (UDP) datagrams, etc. References to L2, L3, L4, and L7 layers (layer 2, layer 3, layer 4, and layer 7) are references respectively to the second data link layer, the third network layer, the fourth transport layer, and the seventh application layer of the Open System Interconnection (OSI) layer model.

A flow can be a sequence of packets being transferred between two endpoints, generally representing a single session using a known protocol. Accordingly, a flow can be identified by a set of defined tuples or header field values and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier. A packet may be used herein to refer to various formatted collections of bits that may be sent across a network, such as Ethernet frames, IP packets, TCP segments, UDP datagrams, etc.

Flows can be configured using NETConf, RESTconf or OpenConfig. Flow identification can include: Multiprotocol Label Switching (MPLS) Label, GRE Tunnel ID, VXLAN ID, VLAN ID, NSH identifier. Where packets are ciphered, outer packet headers can be re-marked with an internal packet header power source type by a ciphering gateway. Instead of, or in addition to, individual packet marking, an outer header of a flow can be marked with meta-data indicating the power source type.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

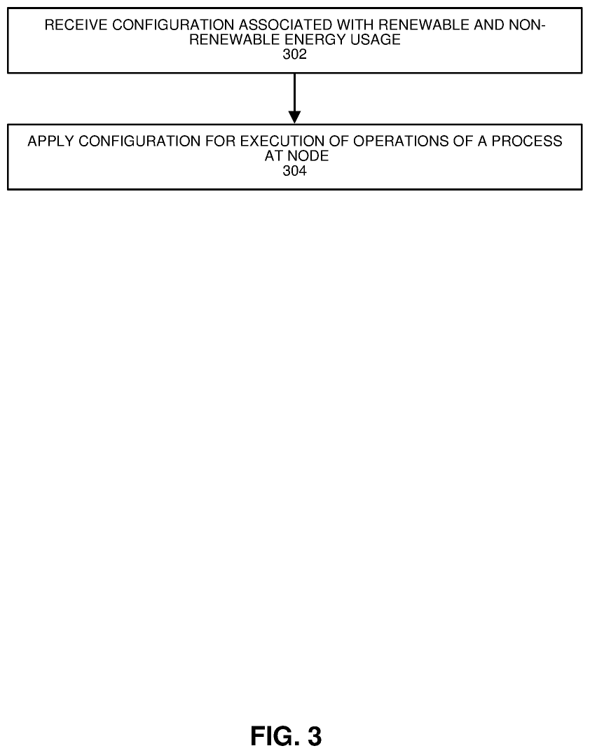

FIG. 3 depicts an example process. The process can be performed by a node and/or network interface device. At 302, a node can receive a configuration specifying renewable and/or non-renewable energy usage for a particular tenant. For example, the configuration can specify parameters described herein such as operations per second, lower level of renewable energy to utilize, upper level of non-renewable energy to utilize, whether to boost performance of a process if excess renewable energy is available, or others.

At 304, based on the configuration, circuitry of a node can allocate renewable and/or non-renewable energy to devices to perform operations of a process. In some examples, the operations of the process can include packet forwarding and/or packet processing operations. In some examples, based on the configuration, where renewable energy is available, performance of the operations can be increased and utilize renewable energy.

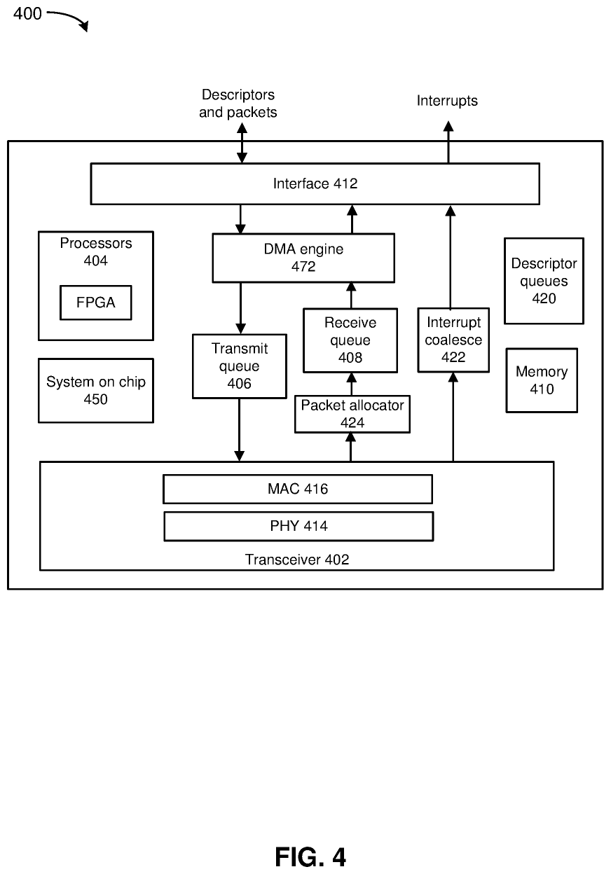

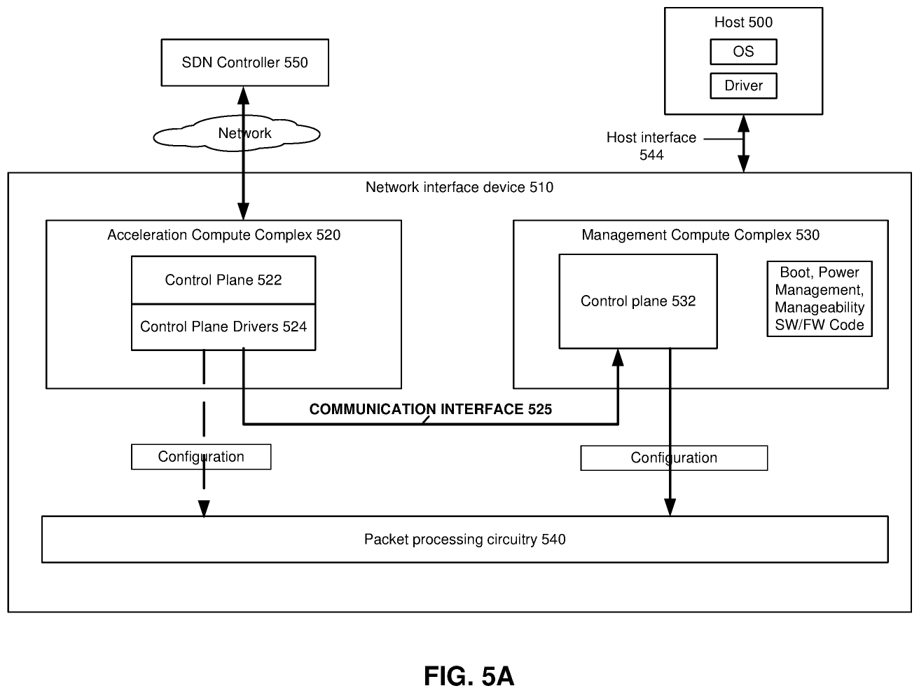

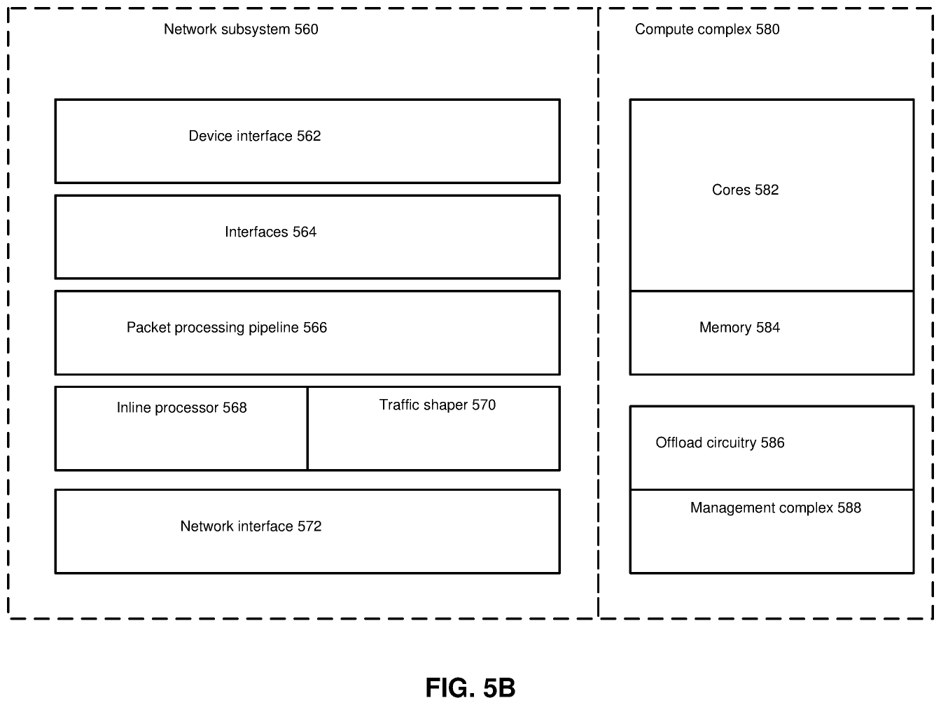

FIG. 4 depicts an example network interface device or packet processing device. In some examples, circuitry of network interface device can be utilized by the network interface or another network interface for packet transmissions and packet receipts as well as by circuitry described at least with respect to FIGS. 5A and/or 5B, as described herein. In some examples, packet processing device 400 can be implemented as a network interface controller, network interface card, a host fabric interface (HFI), or host bus adapter (HBA), and such examples can be interchangeable. Packet processing device 400 can be coupled to one or more servers using a bus, PCIe, CXL, or Double Data Rate (DDR). Packet processing device 400 may be embodied as part of a system-on-a-chip (SoC) that includes one or more processors, or included on a multichip package that also contains one or more processors.

Some examples of packet processing device 400 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 400 can include transceiver 402, processors 404, transmit queue 406, receive queue 408, memory 410, and host interface 412, and DMA engine 452. Transceiver 402 can be capable of receiving and transmitting packets in conformance with the applicable protocols such as Ethernet as described in IEEE 802.3, although other protocols may be used. Transceiver 402 can receive and transmit packets from and to a network via a network medium (not depicted). Transceiver 402 can include PHY circuitry 414 and media access control (MAC) circuitry 416. PHY circuitry 414 can include encoding and decoding circuitry (not shown) to encode and decode data packets according to applicable physical layer specifications or standards. MAC circuitry 416 can be configured to assemble data to be transmitted into packets, that include destination and source addresses along with network control information and error detection hash values.

Processors 404 and/or system on chip (SoC) 450 can include one or more of a: processor, core, graphics processing unit (GPU), field programmable gate array (FPGA), application specific integrated circuit (ASIC), or other programmable hardware device that allow programming of network interface 400. For example, a “smart network interface” can provide packet processing capabilities in the network interface using processors 404.

Processors 404 and/or system on chip 450 can include one or more packet processing pipelines that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 404 and/or system on chip 450, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

As described herein, processors 404, system on chip 450, or other circuitry can be configured to adapt renewable and non-renewable energy usage for a process based on a configuration.

Packet allocator 424 can provide distribution of received packets for processing by multiple CPUs or cores using timeslot allocation described herein or RSS. When packet allocator 424 uses RSS, packet allocator 424 can calculate a hash or make another determination based on contents of a received packet to determine which CPU or core is to process a packet.

Interrupt coalesce 422 can perform interrupt moderation whereby network interface interrupt coalesce 422 waits for multiple packets to arrive, or for a time-out to expire, before generating an interrupt to host system to process received packet(s). Receive Segment Coalescing (RSC) can be performed by network interface 400 whereby portions of incoming packets are combined into segments of a packet. Network interface 400 can provide the coalesced packet to an application.

Direct memory access (DMA) engine 452 can copy a packet header, packet payload, and/or descriptor directly from host memory to the network interface or vice versa, instead of copying the packet to an intermediate buffer at the host and then using another copy operation from the intermediate buffer to the destination buffer.

Memory 410 can be any type of volatile or non-volatile memory device and can store any queue or instructions used to program network interface 400. Transmit queue 406 can include data or references to data for transmission by network interface. Receive queue 408 can include data or references to data that was received by network interface from a network. Descriptor queues 420 can include descriptors that reference data or packets in transmit queue 406 or receive queue 408. Host interface 412 can provide an interface with host device (not depicted). For example, host interface 412 can be compatible with PCI, PCI Express, PCI-x, Serial ATA, and/or USB compatible interface (although other interconnection standards may be used).

FIG. 5A depicts an example system. Host 500 can include processors, memory devices, device interfaces, as well as other circuitry such as described with respect to one or more of FIGS. 4 and/or 5B. Processors of host 500 can execute software such as processes (e.g., applications, microservices, virtual machine (VMs), microVMs, containers, processes, threads, or other virtualized execution environments), operating system (OS), and device drivers. An OS or device driver can configure network interface device or packet processing device 510 to utilize one or more control planes to communicate with software defined networking (SDN) controller 550 via a network to configure operation of the one or more control planes. Host 500 can be coupled to network interface device 510 via a host or device interface 544.

Network interface device 510 can include multiple compute complexes, such as an Acceleration Compute Complex (ACC) 520 and Management Compute Complex (MCC) 530, as well as packet processing circuitry 540 and network interface technologies for communication with other devices via a network. ACC 520 can be implemented as one or more of: a microprocessor, processor, accelerator, field programmable gate array (FPGA), application specific integrated circuit (ASIC) or circuitry described at least with respect to FIGS. 5B and/or 6. Similarly, MCC 530 can be implemented as one or more of: a microprocessor, processor, accelerator, field programmable gate array (FPGA), application specific integrated circuit (ASIC) or circuitry described at least with respect to FIGS. 5B and/or 6. In some examples, ACC 520 and MCC 530 can be implemented as separate cores in a CPU, different cores in different CPUs, different processors in a same integrated circuit, different processors in different integrated circuit.

Network interface device 510 can be implemented as one or more of: a microprocessor, processor, accelerator, field programmable gate array (FPGA), application specific integrated circuit (ASIC) or circuitry described at least with respect to FIGS. 5B and/or 6. Packet processing pipeline circuitry 540 can process packets as directed or configured by one or more control planes executed by multiple compute complexes. In some examples, ACC 520 and MCC 530 can execute respective control planes 522 and 532.

SDN controller 550 can upgrade or reconfigure software executing on ACC 520 (e.g., control plane 522 and/or control plane 532) through contents of packets received through packet processing device 510. In some examples, ACC 520 can execute control plane operating system (OS) (e.g., Linux) and/or a control plane application 522 (e.g., user space or kernel modules) used by SDN controller 550 to configure operation of packet processing pipeline 540. Control plane application 522 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 550 can communicate with ACC 520 using a remote procedure call (RPC) such as Google remote procedure call (gRPC) or other service and ACC 520 can convert the request to target specific protocol buffer (protobuf) request to MCC 530. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 550 can provide packet processing rules for performance by ACC 520. For example, ACC 520 can program table rules (e.g., header field match and corresponding action) applied by packet processing pipeline circuitry 540 based on change in policy and changes in VMs, containers, microservices, applications, or other processes. ACC 520 can be configured to provide network policy as flow cache rules into a table to configure operation of packet processing pipeline 540. For example, the ACC-executed control plane application 522 can configure rule tables applied by packet processing pipeline circuitry 540 with rules to define a traffic destination based on packet type and content. ACC 520 can program table rules (e.g., match-action) into memory accessible to packet processing pipeline circuitry 540 based on change in policy and changes in VMs.

For example, ACC 520 can execute a virtual switch such as vSwitch or Open vSwitch (OVS), Stratum, or Vector Packet Processing (VPP) that provides communications between virtual machines executed by host 500 or with other devices connected to a network. For example, ACC 520 can configure packet processing pipeline circuitry 540 as to which VM is to receive traffic and what kind of traffic a VM can transmit. For example, packet processing pipeline circuitry 540 can execute a virtual switch such as vSwitch or Open vSwitch that provides communications between virtual machines executed by host 500 and packet processing device 510.

MCC 530 can execute a host management control plane, global resource manager, and perform hardware registers configuration. Control plane 532 executed by MCC 530 can perform provisioning and configuration of packet processing circuitry 540. For example, a VM executing on host 500 can utilize packet processing device 510 to receive or transmit packet traffic. MCC 530 can execute boot, power, management, and manageability software (SW) or firmware (FW) code to boot and initialize the packet processing device 510, manage the device power consumption, provide connectivity to a management controller (e.g., Baseboard Management Controller (BMC)), and other operations.

One or both control planes of ACC 520 and MCC 530 can define traffic routing table content and network topology applied by packet processing circuitry 540 to select a path of a packet in a network to a next hop or to a destination network-connected device. For example, a VM executing on host 500 can utilize packet processing device 510 to receive or transmit packet traffic.

ACC 520 can execute control plane drivers to communicate with MCC 530. At least to provide a configuration and provisioning interface between control planes 522 and 532, communication interface 525 can provide control-plane-to-control plane communications. Control plane 532 can perform a gatekeeper operation for configuration of shared resources. For example, via communication interface 525, ACC control plane 522 can communicate with control plane 532 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 525 can be utilized by a negotiation protocol and configuration protocol running between ACC control plane 522 and MCC control plane 532. Communication interface 525 can include a general purpose mailbox for different operations performed by packet processing circuitry 540. Examples of operations of packet processing circuitry 540 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 525 can include one or more mailboxes accessible as registers or memory addresses. For communications from control plane 522 to control plane 532, communications can be written to the one or more mailboxes by control plane drivers 524. For communications from control plane 532 to control plane 522, communications can be written to the one or more mailboxes. Communications written to mailboxes can include descriptors which include message opcode, message error, message parameters, and other information. Communications written to mailboxes can include defined format messages that convey data.

Communication interface 525 can provide communications based on writes or reads to particular memory addresses (e.g., dynamic random access memory (DRAM)), registers, other mailbox that is written-to and read-from to pass commands and data. To provide for secure communications between control planes 522 and 532, registers and memory addresses (and memory address translations) for communications can be available only to be written to or read from by control planes 522 and 532 or cloud service provider (CSP) software executing on ACC 520 and device vendor software, embedded software, or firmware executing on MCC 530. Communication interface 525 can support communications between multiple different compute complexes such as from host 500 to MCC 530, host 500 to ACC 520, MCC 530 to ACC 520, baseboard management controller (BMC) to MCC 530, BMC to ACC 520, or BMC to host 500.

Packet processing circuitry 540 can be implemented using one or more of: application specific integrated circuit (ASIC), field programmable gate array (FPGA), processors executing software, or other circuitry. Control plane 522 and/or 532 can configure packet processing pipeline circuitry 540 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 520 or MCC 530. In some examples, a P4 program can be compiled and provided to MCC 530 to configure packet processing circuitry 540. The following is a JSON configuration file that can be transmitted from ACC 520 to MCC 530 to get capabilities of packet processing circuitry 540 and/or other circuitry in packet processing device 510. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 5B depicts an example network interface device system. Various examples of packet processing device or network interface device 510 can utilize components of the system of FIGS. 4 and/or 5A. In some examples, packet processing device or network interface device can refer to one or more of: a network interface controller (NIC), a remote direct memory access (RDMA)-enabled NIC, SmartNIC, router, switch, forwarding element, infrastructure processing unit (IPU), or data processing unit (DPU). Network subsystem 560 can be communicatively coupled to compute complex 580. Device interface 562 can provide an interface to communicate with a host. Various examples of device interface 562 can utilize protocols based on Peripheral Component Interconnect Express (PCIe), Compute Express Link (CXL), or others as well as virtual device interface such as virtual device interfaces.

Interfaces 564 can initiate and terminate at least offloaded remote direct memory access (RDMA) operations, Non-volatile memory express (NVMe) reads or writes operations, and LAN operations. Packet processing pipeline 566 can perform packet processing (e.g., packet header and/or packet payload) based on a configuration and support quality of service (QoS) and telemetry reporting. Inline processor 568 can perform offloaded encryption or decryption of packet communications (e.g., Internet Protocol Security (IPSec) or others). Traffic shaper 570 can schedule transmission of communications. Network interface 572 can provide an interface at least to an Ethernet network by media access control (MAC) and serializer/de-serializer (Serdes) operations.

Cores 582 can be configured to perform infrastructure operations such as storage initiator, Transport Layer Security (TLS) proxy, virtual switch (e.g., vSwitch), or other operations. Memory 584 can store applications and data to be performed or processed. Offload circuitry 586 can perform at least cryptographic and compression operations for host or use by compute complex 580. Offload circuitry 586 can include one or more graphics processing units (GPUs) that can access memory 584. Management complex 588 can perform secure boot, life cycle management and management of network subsystem 560 and/or compute complex 580.

FIG. 6 depicts a system. In some examples, circuitry of system 600 can manage renewable and non-renewable power supplied to one or more devices to perform a process based on a configuration, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 632, a system administrator, and/or orchestrator can configure network interface 650 to adjust a path to a destination based on a configuration for renewable and non-renewable energy usage, as described herein.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIGS. 4, 5A, 5B, and/or 5C.

In some examples, management controller 644 can perform one or more of: retrieval of server identification and asset information (e.g., health state, temperature sensors and fans, power supply output levels, platform power consumption and thresholds, input/output (I/O) infrastructure data (e.g., host network interface controller media access control (MAC) address(es)) for devices to be managed (e.g., lights-out management (LOM) devices), hard drive status or fault reporting, network-based discovery of service endpoint, discovery of system topology (e.g., rack, chassis, server, node), reboot or power cycle server with connected devices, change boot order of devices, set power thresholds, alert or event notifications, event log access, access and configure management controller network settings, manage management controller user accounts, performing power distribution across the different parts of the system, allocating power management of the host system and network interface device 650, configuring frequency or power of operation of cores and network interface device 650, memory management of host system and network interface device 650, control of software updates of host system and network interface device 650, or control of firmware updates of host system and network interface device 650.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

1. At least one non-transitory computer-readable medium comprising instructions stored thereon, that if executed by one or more processors, cause the one or more processors to:
receive a configuration, wherein the configuration is to specify a first level of renewable energy utilized by one or more devices based on telemetry, wherein the telemetry comprises a level of renewable energy supplied to the one or more devices;
based on a second level of available supplied renewable energy, allocate a portion of the first level of available supplied renewable energy to one or more devices to perform the process; and
based on a third level of available supplied renewable energy, increase renewable energy allocated to the one or more devices, to perform the process, to above the first level.

2. The at least one non-transitory computer-readable medium of claim 1, wherein the configuration comprises an application program interface (API) associated with a tenant of a cloud service provider (CSP).

3. The at least one non-transitory computer-readable medium of claim 1, comprising instructions stored thereon, that if executed by one or more processors, cause the one or more processors to:
based on the first level of available supplied renewable energy, allocate non-renewable energy to the one or more devices to perform the process.

4. The at least one non-transitory computer-readable medium of claim 1, comprising instructions stored thereon, that if executed by one or more processors, cause the one or more processors to:
based on a priority level of the process, delay execution of the process so that additional renewable energy is utilized by the one or more devices to perform the process.

5. The at least one non-transitory computer-readable medium of claim 1, wherein the telemetry is based on a power supply inlet and wherein the power supply inlet comprises a first power inlet to supply renewable energy and a second power inlet to supply non-renewable energy.

6. The at least one non-transitory computer-readable medium of claim 1, wherein the telemetry comprises a signal indicative of a level of supplied renewable energy and a level of supplied non-renewable energy and/or an indicia of greenhouse gas emissions associated with the supplied energy.

7. The at least one non-transitory computer-readable medium of claim 1, comprising instructions stored thereon, that if executed by one or more processors, cause the one or more processors to:
forecast future supplied renewable energy based on prior supplied renewable energy and expected available renewable energy and
schedule execution of the process based on the predicted future supplied renewable energy.

8. The at least one non-transitory computer-readable medium of claim 1, wherein:
the telemetry comprises renewable energy consumption to forward and/or process one or more packets from source to destination and
the process is to perform processing associated with one or more received packet.

9. The at least one non-transitory computer-readable medium of claim 1, wherein the one or more devices comprise: one or more processors, one or more accelerators, one or more application specific integrated circuits (ASICs), one or more field programmable gate arrays (FPGAs), one or more graphics processing units (GPUs), one or more memory devices, one or more storage devices, or one or more network interface devices.

10. An apparatus comprising:
an interface to receive a configuration, wherein the configuration is to specify a level of renewable energy to be utilized for execution of a process based on telemetry, wherein the telemetry comprises a level of renewable energy supplied to a computing platform and
circuitry to:
based on a first level of available supplied renewable energy, allocate a portion of the first level of available supplied renewable energy to one or more devices to perform the process and
based on a second level of available supplied renewable energy, increase renewable energy allocated to the one or more devices, to perform the process, to above the level.

11. The apparatus of claim 10, wherein:
the circuitry is to store renewable energy in an energy storage system (ESS) for subsequent use.

12. The apparatus of claim 10, wherein the circuitry is to receive energy from a power supply inlet, wherein the telemetry is based on the power supply inlet, and wherein the power supply inlet comprises a first power inlet to supply renewable energy and a second power inlet to supply non-renewable energy.

13. The apparatus of claim 10, wherein the telemetry comprises a signal indicative of a level of supplied renewable energy and a level of supplied non-renewable energy.

14. The apparatus of claim 10, wherein the one or more devices comprise one or more of: a network interface device, memory device, a central processing unit (CPU), an accelerator, a memory device, or an interconnect.

15. The apparatus of claim 10, wherein
the renewable energy is based on one or more of solar, wind, or hydroelectric sources and
non-renewable energy is based on one or more of: nuclear power, coal, or gas.

16. The apparatus of claim 10, wherein:
the configuration comprises renewable energy consumption for forwarding and/or processing a packet from a sender to a destination and
the one or more devices comprise a network interface device that is to select a route through one or more switches to the destination based on the renewable energy consumption for forwarding and/or processing the packet from the sender to the destination.

17. A method comprising:
in a data center:
receiving a configuration, wherein the configuration is to specify a level of renewable energy to be utilized for execution of a process based on telemetry, wherein the telemetry comprises a level of renewable energy supplied to a computing platform;
based on a first level of available supplied renewable energy, allocating a portion of the first level of available supplied renewable energy to one or more devices to perform the process; and
based on a second level of available supplied renewable energy, increasing renewable energy allocated to the one or more devices, to perform the process, to above the level.

18. The method of claim 17, comprising:
based on the first level of available supplied renewable energy, allocate non-renewable energy to the one or more devices to perform the process.

19. The method of claim 17, comprising:
based on a priority level of the process, delay execution of the process so that renewable energy is utilized by the one or more devices to perform the process.

20. The method of claim 17, wherein the telemetry comprises a signal indicative of a level of supplied renewable energy and a level of supplied non-renewable energy.

21. The method of claim 17, comprising:
predicting future supplied renewable energy based on prior supplied renewable energy and expected available solar energy and
scheduling execution of the process based on the predicted future supplied renewable energy.
